(19) United States
(12) Patent Application Publication
(10) Pub. No.: US 2005/0194879 A1
(43) Pub. Date: Sep. 8, 2005

(54) Electric bulb and a method for manufacturing thereof

(75) Inventors: Kenji Matsumoto, Imabari-shi (JP); Hirota Watanabe, Imabari-shi (JP); Masahiro Hiraoka, Imabari-shi (JP)

Correspondence Address: BANNER & WITCOFF, 1001 G STREET N W, SUITE 1100, WASHINGTON, DC, 20001, US

(73) Assignee: Harison Toshiba Lighting Corporation, Imabari-shi (JP)

(21) Appl. No.: 11/006,825

(22) Filed: Dec. 8, 2004

(30) Foreign Application Priority Data
Dec. 9, 2003 (JP) 2003-409931

(51) Int. Cl. H01J 19/42; H01J 5/50; H01J 5/48

(52) U.S. Cl. 313/271; 313/623; 445/29; 313/272

(57) ABSTRACT

In an electric bulb wherein a pair of lead-in wires 14a, 14b for suspending a filament 16 is supported with a space by heating and melting a glass bead 15 made of glass, a concave portions 15a, 15b are formed at the contact portion of an outer surface of the glass bead 15 and the lead-in wires 14a, 14b, so that rising of the molten glass along the lead-in wires is suppressed. Thus, break of filament 16 owing to the generation of glass bead chippings or minute cracks is avoided, thereby providing a electric bulb having high production yield and high reliability.

### BACKGROUND TECHNOLOGY OF THE INVENTION

The present invention relates to an electric bulb such as discharge lamp and incandescent lamp which supports lead-in wires suspending a filament with glass beads, and especially relates to an electric bulb in which the manufacturing yield of the electric bulb of the kind is advanced and having a high reliability and to a method for manufacturing it.

In recent years, electric bulbs of the kind, for example, wedge base lamps etc. are widely used for an indication light in measuring instruments of automobiles or in an operating panel of acoustic instruments.

A structure of the wedge base lamp and a method for manufacturing it is shown in Japanese published laid open patent No. TOKUKAI 2001-202925. As shown in FIG. 8, the wedge base lamp has a mount 4, which is formed by loading a filament 3 on one end of a pair of lead-in wire (lead wire) 2a, 2b supported with a space by a glass bead 1. The mount 4 is enclosed inside a glass bulb (not illustrated) to form an electric bulb.

The method for manufacturing the wedge base lamp with such structure is described bellow. Middle portions of a pair of lead-in wires 2a, 2b are inserted in the hole of glass bead 1 which has a ring shape before subjected to a heating process. Next, periphery of the glass bead 1 is heated by a gas burner to melt and it is thereafter solidified. The lead-in wires are supported with a space.

Further, the end of the lead-in wires 2a, 2b are bent to adjust a distance between two ends, where a filament 3 is suspended between the ends to form the mount 4.

Next, the mount 4 thus constructed is inserted in a cylindrical glass bulb with one closed end and open end (not illustrated). The other ends of the lead-in wire are lead out from the open end of the glass bulb. Then, an exhaust tube made of glass (not illustrated) is provided at a prescribed position of the open end of the glass bulb. Then, the open end of the glass bulb is heated and sealed air tight by pressing on both sides.

Next, air inside the pressed and sealed glass bulb is exhausted through the exhaust tube, and inert gas etc. is enclosed in the exhausted glass bulb. The exhaust tube is molten by heating and is pressed to seal, with unwanted portion of the exhaust tube being taken away.

Further, a pair of lead-in wires 2a, 2b lead out through the sealing portion of the glass bulb is bent to form an electrical terminal and an electric bulb is completed.

However, the electric bulbs of such kind have coil shaped filament made of a wire having a very thin diameter, lead-in wire and fragile glass, it is required to strictly control a quality of these parts in manufacturing the electric bulbs. Therefore, to improve the production yield is one of issues in manufacturing electric bulb of such kind.

The inventers of the present invention have analyzed defective in the electric bulb products of such kind, and found that breaking of filament wire was a major cause of the defective. The inventers further investigated and analyzed the causes and revealed that existence of foreign materials inside the glass bulb, especially existence of moving foreign particle is the cause of the breaking of the filament wire.

Here, a small particle of glass or metal is found to be a main moving foreign particle. For example, the small particle of glass is attached on a filament, where is heated locally. It found that the filament is broken finally when the local heating is repeated.

The origin of the small glass particle was mainly from the glass bead enclosed in the glass bulb. That is, in the manufacturing process of wedge base lamp, as described, the glass bead is heated, molten, and solidified, with a pair of lead-in wires supported at a prescribed space. Then, one end of the pair of lead-in wires is bent to adjust the distance between the ends to suspend the filaments. In this process, stress is incurred on the glass bead at the contact portion with the lead-in wire. Thus, it is found that this process causes crack in the glass.

By further analysis of the phenomenon, it was found that when the whole portion of the glass bead is heated and molten by a flame of the gas burner, molten glass goes up along the surface of lead-in wire by a capillary phenomenon at the contact point with the lead-in wire, where a so-called rising portion X is generated at a root of lead-in wire. The rising portion X of glass is thinner at an upper end than at the root portion, the vertical section of which has nearly triangle shape. Thus, chip or minute crack takes place especially in the thin portion at the upper end at the bending of the bending process of the lead-in wire described above.

Electric bulbs having chip or minute crack on the glass surface rising along the surface of lead-in wires are eliminated in the inspection process after fabrication. However, in electric bulbs which passed inspection process having minute cracks, the cracks may proceed by vibration or shock in the following actual use to generate minute glass particles which move inside the bulb and attach on filament coil. As a result, it became clear that filament coil breaks in shorter time than actual lamp life as mentioned above.

Therefore, one of the objects of the present invention is to prevent the filament break resulting from the moving foreign particles enclosed inside the bulb based on the knowledge mentioned above, and to supply electric bulbs having a long life as well as to provide a method for manufacturing it.

### SUMMARY OF THE INVENTION

An electric bulb according to an embodiment of the present invention includes, a pair of lead-in wires which are supported with a space to each other by heating and melting a glass bead, a mount composed of a filament suspended between ends of the pair of lead-in wires, and a glass bulb wherein the mount is enclosed and a part of the lead-in wires are lead out of the glass bulb, wherein an outer surface of the glass bead contacting with the lead-in wire is essentially prevented from rising along the lead-in wire.

Owing to the structure, a chipping or minute crack hardly occurs when the lead-in wire is bent.

In the electric bulb according to an embodiment of the present invention, a concave portion is formed on the outer surface of the glass bead at the contact portion with the lead-in wire.

That is, the rising of the molten glass at a surface of the glass bead along the lead-in wire can be suppressed by the concave portion formed on the outer surface of the glass bead around the lead-in wire. It is therefore possible to prevent the chipping or minute crack from occurring when lead-in wire is bent.

Here, the concave portion, which suppress the rising of the glass on the bead surface along the lead-in wire, is formed on the bead in a situation where the contact portion of the outer surface of the glass bead with the lead-in wire on the filament side is depressed, which means that the rising of the glass along the lead-in wire is inhibited during a process for forming the concave portion. To prevent the glass from rising, it is preferable that each concave portion having a crater shape is formed relatively deep with each lead-in wire positioned at a center of the concave portion. However, the shape of the concave portion or depth etc. is not limited to one shown above.

A method of manufacturing an electric bulb according to an embodiment of the present invention includes steps of inserting a pair of lead-in wires through a center hole of a bead made of glass and tentatively fixing them with a space between them, and heating mainly a lower side portion of the bead.

According to the method for manufacturing the electric bulb mentioned above, the lower portion of the glass bead melts earlier than the upper portion of the glass bead, and thus the lower portion of the center hole of the bead is closed first.

Further, according to the method for manufacturing, the lower portion of the side of the bead is heated by a pair of burners having three tip nozzles arranged in nearly horizontal direction, which are arranged on left and right sides of the bead.

Further, according to the method for manufacturing, the surfaces of the bead heated by the pair of burners are surfaces on both side of a plane defined by the pair of lead-in wires.

Further, according to the method for manufacturing, the diameter of center tip nozzle is larger than those on both side tip nozzles, and thus the heating power of the center portion is stronger than those on both sides in the lower left and right side portion of the bead.

A method for manufacturing an electric bulb according to the other embodiment of the present invention includes steps of inserting a pair of lead-in wires into a center hole of a glass bead and tentatively fixing the wires with a space to each other, a first burner step for heating mainly whole side of the bead through which the pair of lead-in wires are tentatively fixed, a second burner step for heating mainly the middle portion in the vertical direction of the side of the bead, and a third burner step for heating mainly the lower portion of the side of the bead.

Further, according to the method for manufacturing an electric bulb, the burners used in the first burner step having a single tip nozzle are arranged on left and right sides of a plane defined by the pair of lead-in wires, and heat the whole part of the side of the bead.

Further, according to the method for manufacturing an electric bulb, the burners used in the second burner step having two tip nozzles arranged in substantially horizontal direction are arranged on left and right sides of the plane defined by the pair of lead-in wires, and heat the middle portion of the side of the bead.

Further, according to the method for manufacturing an electric bulb, burners used in the third burner step having three tip nozzles arrayed substantially in horizontal direction are arranged on left and right side of the plane defined by the pair of lead-in wires, and heats the lower portion of the side of the bead.

Further, according to the method for manufacturing an electric bulb, a diameter of the tip nozzle of the burners having two tip nozzles is smaller than the diameter of the tip nozzle of the burners having the single tip nozzle, while the diameter of the tip nozzle of the burners having three tip nozzles is smaller than the tip nozzle diameter of the burners having two tip nozzles. Besides, in the three tip nozzles arrayed in substantially horizontal, the diameter of the center tip nozzle is larger than the diameter of the tip nozzle on both sides to make the fire at the center portion is stronger than those on both sides.

Further, according to the method for manufacturing an electric bulb, the lead-in wires are bent at a portion above the bead for adjusting a distance between the ends of the lead-in wires after heated and molten bead is solidified.

Further, according to the method for manufacturing an electric bulb, the mount having the pair of lead-in wires with the distance between the ends being adjusted is enclosed in an air tight vessel made of a translucent material with one end sealed and the other end open, through which the other ends of the pair of lead-in wires are lead out of the air tight vessel.

### BRIEF DESCRIPTION OF THE DRAWINGS

FIG. 1 is a perspective and enlarged view showing an electric bulb according to an embodiment of the present invention.

FIG. 2 is a front and enlarged view showing an enlarged view of a mount of an electric bulb according to an embodiment of the present invention.

FIG. 3 is a side and enlarged view showing a mount of an electric bulb according to an embodiment of the present invention.

FIG. 4 is an upper and enlarged view showing a mount of an electric bulb according to an embodiment of the present invention.

FIG. 5 is a cross section along A-A line of FIG. 4.

FIG. 6 is a flow chart showing a rough manufacturing process of the electric bulb according to an embodiment of the present invention.

FIG. 7 is a rough schematic diagram showing a heating process in a method for manufacturing of an electric bulb according to an embodiment of the present invention. Here, (a-1), (b-1), (c-1) are schematic diagram of front view, (a-2), (b-2), (c-2) are schematic diagram of side view, (a-3), (b-3), (c-3), (c-3′) are schematic diagram of side view showing rough bead shapes at each heating process.

FIG. 8 is a schematic diagram showing the heating process in the method for manufacturing of an electric bulb according to an embodiment of the present invention continued from FIG. 7. Here, (d-1), (e-1) are schematic diagram of front view, (d-2), (e-2) are schematic diagram of side view, (d-3), (d-3′), (e-3) are schematic diagram of side view showing rough bead shapes at each heating process.

FIG. 9 is a cross section showing a part of a mount in a conventional electric bulb.

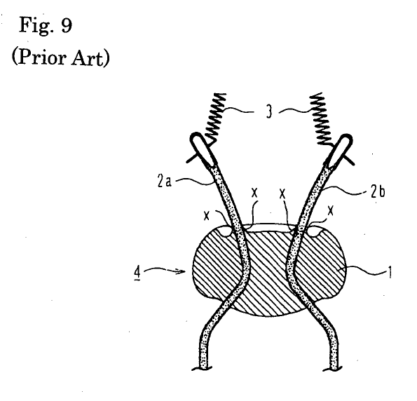

### DETAILED DESCRIPTION OF THE INVENTION

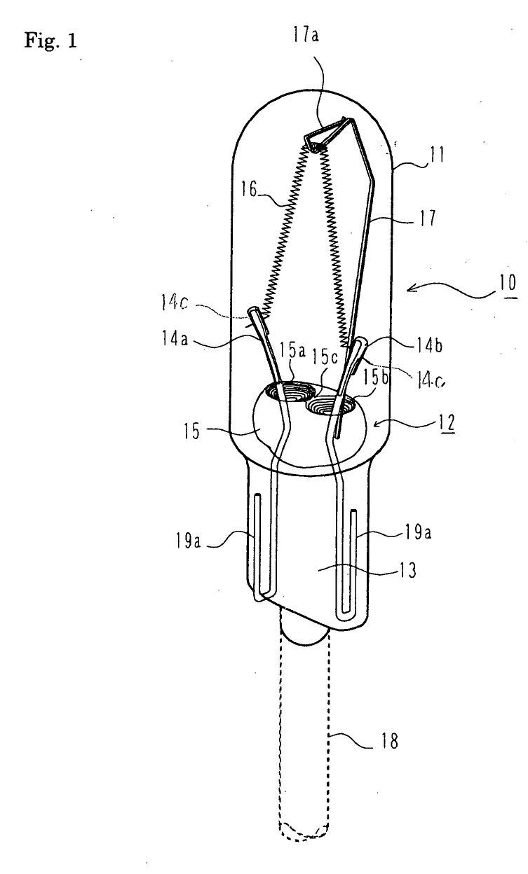

Now, an electric bulb and a method for manufacturing it according to an embodiment of the present invention will be explained. First, a construction of the electric bulb will be explained referring to from FIG. 1 to FIG. 5. FIG. 1 is a perspective and enlarged view showing an electric bulb according to an embodiment of the present invention. As shown in the figure, an electric bulb 10 of wedge base type (T5 type) is composed of a glass bulb 11 which is a translucent air tight vessel, a mount 12 enclosed in the glass bulb, and a sealing portion 13 including an exhaust tube portion.

The height of the electric bulb is about 20 mm from the top end of the glass bulb 11 to the lower end of the sealing portion 13. The outer diameter of the glass bulb 11 is about 4.75 mm, or about 4.85 mm (with a wall thickness of 0.52 mm).

Hereinafter, a part of the electric bulb 10 where the mount 12 is formed is referred as upper side, and a part where the sealing portion 13 is formed is referred as lower side.

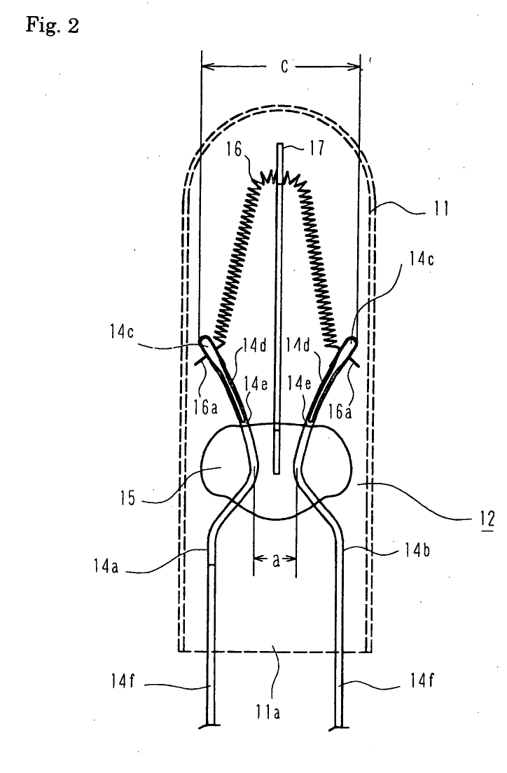

The glass bulb 11 is made of a translucent soft glass, or a lead free soft glass, which has one end sealed and other end forming an opening 11a (indicated by a broken line in FIG. 2).

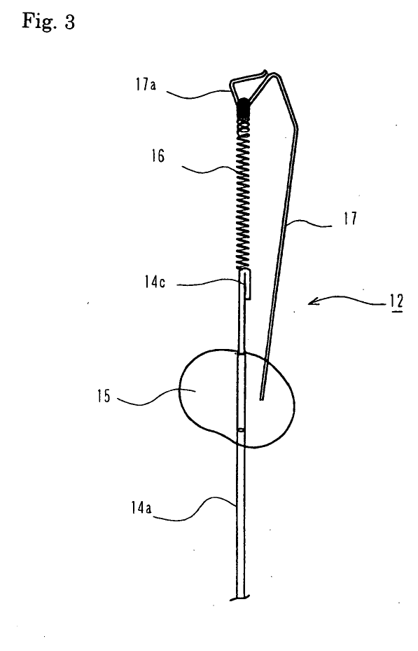

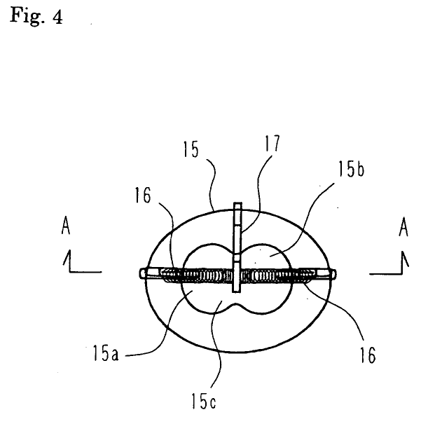

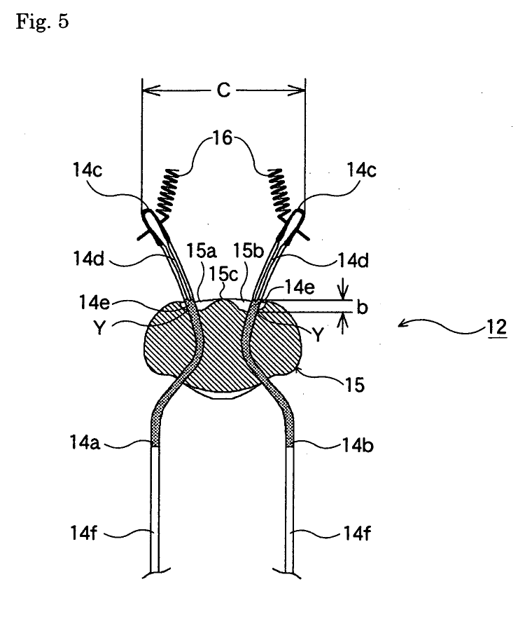

FIG. 2 is a front and enlarged view showing a mount 12 of the electric bulb 10 and FIG. 3 is a side and enlarged view showing the mount. FIG. 4 is an upper and enlarged view also showing the mount and FIG. 5 is a cross section along A-A line of FIG. 4. As shown in these figures, the mount 12 is composed of a pair of lead-in wires 14a, 14b, a glass bead 15 for supporting the lead-in wires with a prescribed space to each other, a filament 16 suspended on upper ends of the pair of lead-in wires, and an anchor 17 which lifts the filament at nearly center portion and supports it in nearly inverted “V” shape.

A pair of lead-in wires 14a, 14b is a nickel plated Dumet wire, which is made of iron-nickel alloy coated with copper. The lead-in wire is formed in a cylinder shape having a diameter of about 0.25 or 0.3 mm. Upper end of the lead-in wire is pressed to form a flat compressed portion 14d with nearly an oblong shape. The compressed portion 14d is folded back to form hook portion 14c, in which a leg portion 16a of the filament 16 formed at its both ends is inserted. The hook portion 14c is compressed to pinch the leg portion 16a, so that the both ends of the filament 16 are suspended on the upper ends of the pair of lead-in wires 14a, and 14b .

Anchor 17 is composed of molybdenum wire with a diameter of 0.12 or 0.15 mm.

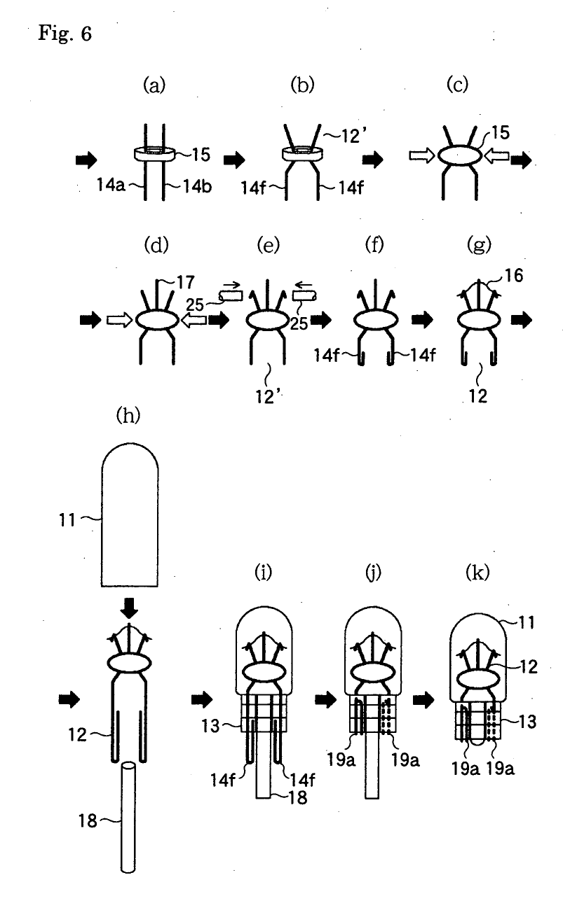

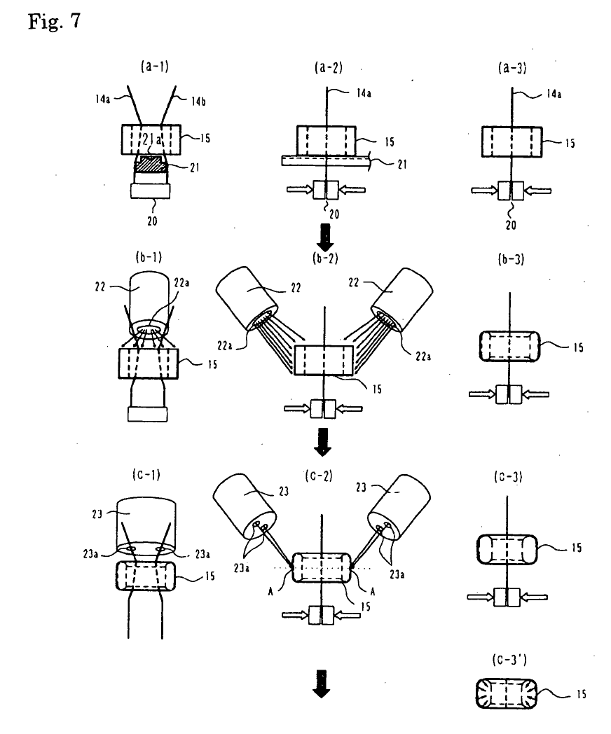

A glass bead 15 is composed of a translucent glass material similar to the glass bulb 11. The glass bead 15 is formed in a cylindrical shape having an outer diameter of 3.15 mm, an inner diameter of 2.35 mm (with a wall thickness of 0.4 mm) and a height of 1.5 mm, before it is subjected to a heating process, as shown in FIG. 6 or FIG. 7. The glass bead 15, being heated to melt and thereafter being solidified, supports a pair of lead-in wires 14a, 14b with space of about 0.8 mm to each other as shown in FIG. 2. The glass bead 15 is put into the glass bulb 11 at a position where it is seen from outside of the electric bulb when it is assembled.

As shown in FIG. 5, the glass bead 15 turns into a glass body when it is heated, molten, and solidified. Concave portions 15a, 15b, which are shown by Y in the figure, are formed at portions where the outer surface of glass bead 15 is in contact with the outer surfaces of the lead-in wires 14a and 14b on the filament side at so-called the root portion of the lead-in wire. These concave portions 15a, 15b are formed by a crater shape depression around the lead-in wires 14a, 14b. Between these concave portions 15a, 15b, a groove shaped depression 15c connecting them mutually is formed.

Here, the X portion, where a rising of the glass of bead surface along the lead-in wire, is not formed because the concave portions 15a, 15b are formed by the depression at the contact portion Y between the outer surface of the glass bead 15 and the outer surface of lead-in wire 14a, 14b on the filament 16 side, as mentioned above.

Next, the lead-in wire which extends upward from the outer surface of the bead has a wire portion 14e of circular cross section, where is at about 0.2 mm distance from the outer surface of the bead shown with b in FIG. 5. The lead-in wires 14a, 14b are bent at the wire portion 14e so as to the upper ends are extending outside. Also at this portion, a pitch adjustment is carried out for adjusting the distance c (FIG. 2) to the length of the filament 16, which is about 2.7 to 2.9 mm as described later.

The mount 12 constructed in a way mentioned above is inserted into the glass bulb 11 from its opening portion 11a, with flat portions 14f, 14f of the lower ends of lead-in wires 14a, 14b being led out from the opening portion 11a of the glass bulb 11. An exhaust tube 18 made of glass (shown with a broken line in FIG. 1) is provided at a prescribed position of the glass bulb opening 11a, and the opening portion 11a of glass bulb 5 is heated, molten and sealed air tight by compressing a sealing portion 13 from both sides of it.

Further, the flat portions 14f, 14f of the pair of lead-in wires 14a, 14b are lead out from the sealing portion 13 of the glass bulb 11 and are bent in opposite direction to each other along both surfaces of the sealed portion 13 to form electrical terminal portion 19a, 19a.

Next, the glass bulb 11, which is sealed by being compressed, is exhausted to vacuum through the exhaust tube 18 and thereafter being heated seals the exhaust tube 18, thereby forming the sealed portion 13 by removing unwanted portions.

The wedge base type electric bulb 10 thus constructed has no glass fragment, which consists moving foreign particles, in the glass bulb 11. The electric bulb is mounted on a circuit board, for example, composing instrument panel of automobile, with the terminal portion 19a, 19a, being pressed into a socket provided on the circuit board. With electric power being supplied, the electric bulb is lit, which is used as an indicator lamp of instrument panel.

According to the embodiment of the present invention described, the rising of the glass on the surface of the glass bead along the lead-in wires can be prevented from occurring. Thus, the chipping of glass bead or minute cracks which are apt to occur in bending process of lead-in wires can also be prevented from occurring, thereby improving the production yield and providing the electric bulbs having excellent reliability.

Also, according to the embodiment of the present invention described, the concave portions are provided which prevent the glass from rising from the surface of the glass bead along the lead-in wires. Thus, chipping of glass bead or minute cracks which are apt to occur in bending process of lead-in wires can be prevented from occurring, thereby improving the production yield and providing the electric bulbs having excellent reliability., production yield can be improved, electric bulbs having excellent reliability can be supplied.

Here, the material, the dimension or the position where the pair of the lead-in wire is supported of the glass bead 15 in the embodiment described can be modified in various ways according to the types or species of the electric bulbs.

Although the glass bead 15 was arranged at a position where it is visible from outside of the glass bulb 11, the glass bead may be buried in the sealing portion 13 at the opening portion 11a of the glass bulb.

Although the concave portion 15c of the glass bead 15 is formed in a groove shape between the concave portion 15a and 15b for mutual connection, the mutual connection is not always necessary, and all sorts of variations of the shape or depth of the concave portion 15c are possible.

Further, although the glass rise on the surface of the glass bead 15 along the lead-in wire 14a, 15b was prevented completely from occurring in the embodiment described, a part of glass rise may remain.

Further, although the glass bulb 11 was evacuated to vacuum in the embodiment described, inert gas such as neon, argon, xenon etc. or a mixed gas of these gases may be enclosed.

Further, the electric bulb is not limited to wedge base type electric bulb but other small size incandescent lamp may be used.

Next, a method for manufacturing of the electric bulb according to an embodiment of the present invention will be explained referring to from FIG. 6 to FIG. 8.

FIG. 6 to FIG. 8 is a flow chart roughly showing a manufacturing process of the electric bulb, in which the following steps are sequentially carried out using an automated machine: a tentative bead fixing step, a lead-in wire bending step, a bead heating step, an anchor supporting step, a hook forming step, a lead-in wire pitch adjust step, an electrode terminal forming step, a filament suspension step, a glass bulb inserting step, a bulb sealing step, an electrode lead forming step, and an exhaust step.

First, in the tentative bead-fixing step, a pair of lead-in wires 14a, 14b is inserted through a center hole of a cylindrical glass bead 15 before it is subject to a heating step. Lower ends of the lead-in wires 14a, 14b are supported and fixed by a holder 20 (FIG. 7) of the machine. Here, when the glass bead 15 is heated and molten in the later step, a space between the lead-in wires 14a and 14b is controlled to be a prescribed one.

Then, the glass bead 15 is moved to the lead-in wire-bending step. In this step, the pair of lead-in wires 14a, 14b inserted in the glass bead 15 in parallel, is bent at the wire portion 14e over a root portion Y so as to extend the space between them, as shown in FIG. 5. Further, the pair of lead-in wires 14a, 14b, after being extended outwards in the glass bead 15, is folded in parallel at the lower flat portions 14f, 14f of the glass bead 15.

As a result, a preliminary mount 12′ is constructed, wherein the pair of lead-in wires 14a, 14b is inserted through the hole of cylindrical ring shaped glass bead 15 before heating step, and wherein the glass bead 15 is tentatively fixed.

The preliminary mount 12′ is supported in nearly vertical direction by a chuck 21 of an automatic machine. On an upper surface of the chuck 21, a concave portion 21a made of a “V” shaped groove is formed facing to the lower surface of the glass bead 15. The preliminary mount 12′ held with a holder 20, and the chuck 21 moves to bead heating step.

The bead heating step includes three steps: a first burner step which is a preliminary heating step of the bead, a second burner step which is a primary baking step of the bead, and a third burner step which is finishing baking step of the bead.

As mentioned above, the glass bead 15 before heating step has a ring shape or a cylindrical shape as shown in FIG. 7 (a-3) , and it is moved to a first burner step. Here, lower ends of the pair of lead-in wires 14a, 14b are supported by the holder 20 of the machine. Consequently, the glass bead 15 is held with no rotation in each burner step described later, so that the flame of the burner heats always the same portions on the left and right side surfaces of the glass bead 15.

In the first burner step, which is the preliminary heating step, a pair of an one hole burners 22, 22 of substantially same specifications is provided to heat the glass bead 15 evenly from left and right side of the glass bead 15, as shown in FIG. 7 (b-1, b-2). Tip nozzles 22a, 22a of each one-hole burner 22, 22 are arranged at a diagonally upper position of left and right side of glass bead 15. Here, the left and right side surfaces of the glass bead 15 means the surfaces of the glass bead 15 on both sides of a plane defined by the pair of spaced lead-in wires 14a, 14b inserted into the glass bead 15. The words are used in the following explanation to have the meaning described.

The tip nozzles 22a, 22a of each one hole burner 22, 22 have relatively larger bore diameters than those of other burners described later, and heat the glass bead 15 with a flame of moderate heating power emitted from the tip nozzle from diagonally upper positions on the left and right side of the glass bead 15. Thus, the glass bead 15 having the pair of lead-in wires inserted through it is heated on the whole side surface and the bead is wholly heated. In the first burner step, the glass bead 15 begins to be melting at the lower portion on the left and right side surfaces. In this state, the glass bead 15 moves to the second burner step, the next primary baking step of the bead as shown in FIG. 7(b-3).

In the second burner step, the glass bead 15 is heated evenly from left and right sides by a pair of a two hole burners 23, 23 of substantially same specification as shown in FIG. 7 (c-1), (c-2) . The two tip nozzles 23a, 23a of each burner 23, 23 are provided at diagonally upper positions of left and right sides of the glass bead 15.

The two tip nozzles 23a, 23a of each burner 23, 23 have smaller bore diameter than those of the tip nozzles 22a, 22a of the one hole burner 22, 22 in the first burner step, and thus narrowed down flames are shot from the tip nozzles to the middle portion A in a vertical direction of the side surface of the glass bead 15 in the diagonal direction on the left and the right side of the glass bead 15. As a result, heating and melting of the glass bead 15 are accelerated mainly at the middle portion of the side surfaces, and the molten glass tends to become spherical shape, which has smallest surface area and is stable (FIG. 7(c-3′)).

In this way, the glass bead 15 begins to change its shape from cylindrical to spherical, and the center hole of the cylindrical glass bead 15,through which the pair of lead-in wires 14a, 14b are inserted, decreases its diameter. As a result, glass begins to deposit on the surface of each lead-in wires 14a, 14b, as shown in FIG. 7(c-3). In this state, the glass bead 15 moves to the third burner step, which is the finishing baking step.

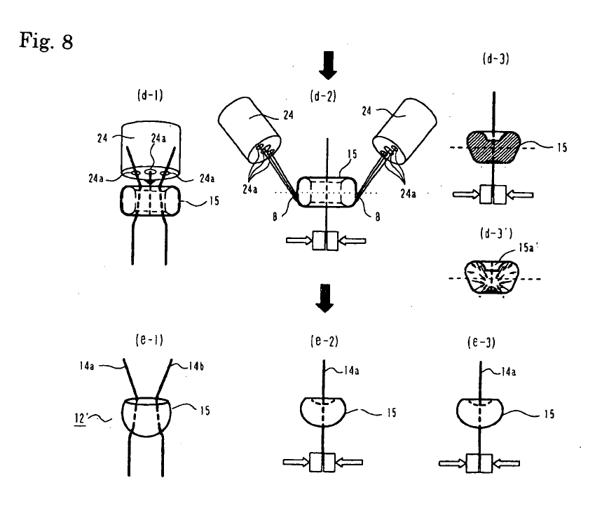

In the third burner step, the glass bead 15 is heated evenly from left and right sides by a pair of a three hole burner 24, 24 of substantially same specification, as shown in FIG. 8 (d-1) and (d-2) . The three tip nozzles 24a, 24a, 24a of each burner 24, 24 are provided on a diagonally upper position of the glass bead 15.

The three tip nozzles 24a, 24a, 24a of each burner 24, 24 have smaller bore diameters than those of the tip nozzles 23a, 23a of the two hole burner 23, 23 in the second burner step, however, the center tip nozzle 24a has somewhat larger bore diameter than those of tip nozzles 24a, 24a on both sides. Accordingly, as a whole, the burners of the third burner step are narrowed down thinner than the flames of the burner 23, 23 of the second burner step. Besides, the center flame is made stronger than the left and right flames, and the flame is shot from the diagonally upper position on the left and the right sides of the glass bead 15 to the lower portion B in the vertical direction to heat mainly the lower portion of the side surfaces of the glass bead 15.

Thus, the lower portion of the glass bead 15 is heated stronger than other portions, which begins to be spherical as a whole by being soften and molten, and thus the lower portion of the center hole of the bead is closed first, with the glass being attached on the surface of each lead-in wires. At this time, the glass is molten and an opposing inner walls of the center hole of the bead 15 are made in contact to each other through the space between the pair of lead-in wires because the center portions in the horizontal direction of the left and right side surfaces are especially strongly heated. In this manner, the lower portion of the center hole of the glass bead 15 becomes smaller earlier, and because the center portion of left and right side surface is mutually made contact earlier than other portion, the glass softened at the upper portion of the center hole of the bead is drawn in toward lower central portion. As a result, a depression 15a′ is formed on the upper surface of the glass bead (FIG. 8 (d-3′)).

At this time, the molten glass moves downward, which is an opposite direction to the rising of the glass at the surface of each lead-in wires, which are in contact with the depression 15a′ on the upper side of bead, thus the rising of the glass is suppressed in its height and rising of the glass portion is hardly found.

Further, since the heating of the glass bead 15 by the burner flame is concentrated to the lower portion of the side surface of the bead as mentioned above, the temperature of the upper portions of lead-in wires 14a, 14b is apt to become lower. As a result, with the bead glass which is molten and in which the center portion is drawn downward and which is turning into spherical shape, the capillary phenomenon of the glass along the lead-in wires decreases according to the lowering of the temperature of the lead-in wire, and thus the rising of the glass on the surface of each lead-in wires decreases or hardly occurs.

Such results can be obtained by mainly heating the lower portion of the side surfaces of the glass bead, instead of heating to melt the whole glass bead. That is, if the whole glass bead is heated to melt, the molten glass generates a rising of the glass on the surface of lead-in wires due to the capillary phenomenon at the contact portion of glass and lead-in wire, which is the so-called root portion of lead-in wire. Moreover, when the lead-in wire and the bead are heated at nearly equal temperature, the capillary phenomenon is easy to occur as well as the rising of the glass is easy to arise.

The glass bead 15 and a pair of lead-in wires 14a, 14b is cooled in a state where the rising of the glass is suppressed or it is hardly found, the preliminary mount 12′ is then deformed as shown in FIG. 8 (e-1), (e-3) , and in FIG. 5 for more details. That is, the glass bead 15 has changed into a nearly spherical glass body, and the contact portion between the outer surface of glass bead 15 of the glass body and the lead-in wire 14a, 14b on the filament 16 side, namely the root portion of the lead-in wire Y, is depressed. Concave portions 15a, 15b composed of crater shaped relatively deep depression are formed at the root portion Y of the lead-in wire. A concave portion 15c is formed, which connects the crater shaped concave portions 15a, 15b mutually. In the concave portions 15a, 15b, rising of the glass of bead surface to lead-in wires conventionally found is completely or hardly found.

Further, the pair of lead-in wires 14a, 14b has the wire portion 14e of spherical cross section protruding and being exposed from the outer surface of the glass bead at an adjacent portion of the contact portion Y of the outer surface of the glass bead and the lead-in wires, shown as b (about 0.8 mm) in FIG. 5. The preliminary mount thus constructed is carried to the next anchor support step.

In anchor support step, the glass bead 15 is heated again to melt and an anchor 17 is extended from upper position and is inserted into the molten glass bead at nearly center portion thereof, thereby lower portion of the anchor 17 being embedded in the glass bead. Thereafter, the glass bead 15 is cooled and solidified to support the anchor 17.

Next, the preliminary mount is carried to a hook formation and a lead-in wire pitch-adjusting step. In this step, first, a hook portion 14c is formed by pressing the lead-in wires 14a, 14b as shown in FIG. 1 to FIG. 3 for hanging the leg portion 16a, 16a at both ends of the filament 16. With the glass bead 15 being cooled and solidified, the space of upper ends of the pair of the lead-in wires 14a, 14b, which has been varied due to a fluctuation in processes, is adjusted to be a predetermined distance.

As shown by data in Table 2, which is a test result of evaluation on reproduction mentioned later, initial distance of a space, which is a space between the upper end portions of lead-in wire 14a, 14b, is varies from MIN=3.49to MAX=3.76 mm with average distance of AVE=3.6465 mm, showing a fluctuation of wide range. Thus, there exist a number of half mounts 12′, which cannot enter the glass bulb 11 because they may contact with the inner wall of the glass bulb 11. Therefore, both ends of a pair of lead-in wires 14a, 14b are compressed to be bent by a pair of presser 25, 25 of automatic machine from left and right sides with equal power, so that the distance between the lead-in wires 14a and 14b is adjusted to be 2.9 mm. Thus, all the preliminary mount 12's are able to enter into the glass bulb 11.

When adjusting the lead-in wire pitch, if the rising of the glass X of glass bead surface to lead-in wire exists as in the case of the conventional electric bulb, stress is applied on the rising of the glass portion X by bending the pair of lead-in wires 14a, 14b, and the glass chip or minute crack is generated. However, according to the method for manufacturing described above, the glass chip or minute crack is not generated, because the fabrication of the bulb is carried out while the rising of the glass does not or seldom exist.

Further, at the wire portion 14e of a circular cross section, the pair of lead-in wire 14a, 14b is exposed from the contact portion Y with the outer surface of glass bead 15. The pair of lead-in wire 14a, 14b is bent to extend the space between the upper ends at a flat portion 14d formed at a slightly upper position from Y. Thus, the bending can be done with a smaller pressing force compared with the case where the bending is carried out at the wire portion 14 of the circular cross section. For this reason, a large stress is not applied to the contact portion Y of the outer surface of the glass bead 15 and the lead-in wire 14a, 14b, the generation of chip or minute cracks in glass bead 15 can be suppressed further. Thus, a preliminary mount 12′ is produced, in which the distance of the space c of the pair of lead-in wires 14a, 14b supported by the glass bead 15 is controlled. Besides, the preliminary mount 12′ can be produced in a state where the glass fractions are not attached on the glass bead 15 or on the lead-in wire 14a, 14b.

Next, the half mount thus produced is carried to the electrode terminal-forming step. In this step, the lead-in wire 14a, 14b are folded at their flat portions 14f, 14f, which are lead out of the bulb when it is fabricated. As a result, the contact area between the electrode terminal and a socket terminal of the electric bulb increases by the nearly “U” shaped electrode terminal.

Next, the preliminary mount 12′ is carried to the filament suspension step. In this step, the upper portion of the anchor 17 is bent to form a hook portion 17a, where a center portion of the filament 16 is hooked. The leg portion 16a, 16a at the both ends of the filament are inserted into minute gaps, which are formed inside the hook portion 14c, 14c folded in the hook forming step described, and the outer side of the hook portion 14c, 14c is compressed by a press to fix the filament not to drop off, thereby mount 12 being completed.

Here, the pair of lead-in wires 14a, 14b is controlled in the distance c in the lead-in wire pitch-adjusting step described, so the length of the filament 16 becomes always constant.

Next, the completed mount 12 is carried to the glass bulb-inserting step. In this step, a cylindrical glass bulb 11, which is sealed its one end in semispherical shape and having an opening portion 11a in another end and cut in prescribed length in other step, is carried in. The completed mount 12 is inserted in the glass bulb 11 from the opening portion 11a. In this case, the mount 12 is inserted and is so located that the both ends of the pair of the lead-in wire 14a, 14b does not contact with the inner wall of the glass bulb 11. In this state, the exhaust tube 18 made of glass, which is cut in prescribed length in other step, is carried in. The exhaust tube 18 is arranged in a state the top end is inserted in the glass bulb 11 trough the opening portion 11a, as shown by a part broken line in FIG. 1.

The glass bulb 11 wherein the mount 12 and the exhaust tube 18 is inserted is carried to the next bulb-sealing step. In this step, the opening portion 11a of the glass bulb 11 is heated and is compressed from both sides for sealing. At this time, the exhaust tube 18 is not compressed.

Next, the mount 12 is carried to the electrode lead forming step, in which the pair of lead-in wires 14a, 14b, lead out from the sealing portion 13 of the glass bulb 11 are folded in opposite direction to each other to form terminal portion 19a, 19a.

Further, the mount 12 is carried to the exhaust step, in which air in the sealed glass bulb 11 is exhausted to vacuum through the exhaust tube 18, and thus the sealing portion 13 is formed, wherein the glass bulb 11 is kept air tight taking away unwanted portion of the exhaust tube 18.

The wedge base type electric bulb is completed after finishing inspection step and marking step.

The wedge base type electric bulb 10 thus completed is hardly subject to filament break and having excellent reliability can be obtained, because there exists no moving foreign particles like glass fractions inside the glass bulb 11.

Next, an evaluation test result will be explained, with which generation of the bead crack in a conventional mount and in a mount according to the embodiment of the present invention.

First, the evaluation method and the generation of the bead crack in the conventional mount will be explained referring to Table 1. In the bead heating step, the mount finished the bead baking is taken out from the machine and the distance of the lead-in wires is measured with a slide caliper (n(number of samples)=100 P (piece)). The measured value is indicated as “A: Initial space data of the lead-in wires” in the Table.

Next, to make all mounts to have a dimension to be inserted into the glass bulb, the space of the pair of lead-in wires is decreased to 2.9 mm (aiming a designed distance) by pressing them from an outer to an inner side with a slide caliper. As a result, 27 pieces out of 100 P, that is, 27/100 P was defective due to the bead crack.

Next, using the mount of MIN product having the initial distance of 3.65 mm, the narrowest, and the mount of MAX product with the initial distance of 3.72 mm, the widest, the dimension when crack is generated is recorded (B: the space between the lead-in wire when the bead cracked occurred) in the Table 1, when the space was narrowed by slide caliper with the same method as above, and a bent distance of the lead-in wire was calculated (C: reduced critical distance of crack generation C=(A−B)/2) indicated in the table. The result is explained referring to Table 1.

Result with MIN Product
1) A: 3.65 mm: initial distance before applying pressure on the lead-in wire with the slide caliper
2) B: 2.54 mm: the distance between the lead-in wires when the crack s generated on the right side
3) C: 0.56 mm: the reduced critical distance of right side crack generation
   with bending by (3.65−2.54)/2=0.56 mm, crack was generated at the rising portion X of the lead-in wire on the right side, no defect is found on the left side.

By further bending to inner side,
4) B: 1.81 mm: the distance between the lead-in wires when the crack generated on the left side
5) C: 0.92 mm: reduced critical distance of the crack generation on the left side
   by bending (3.65−1.81)/2=0.92 mm, crack was generated at the rising portion X of the lead-in wire on the left side

Result of MAX Product
1) A: 3.72 mm: the initial distance before applying pressure on the lead-in wire with the slide caliper
2) B: 3.23 mm: the distance of the lead-in wires when the crack generated on the right side
3) C: 0.25 mm: the reduced critical distance of the crack generation on the right side
   by bending (3.72−3.23)/2=0.25 mm, the crack was generated at the rising portion X of the lead-in wire on the right side, however no defect on the left side.

By further bending to inner side,
4) B: 3.02 mm: the distance between the lead-in wires when the crack generated on the left side
5) C: 0.35 mm: the reduced critical distance of the crack generation on the left side
   with bending by (3.72−3.02)/2=0.35 mm, the crack was generated at the rising portion X of the lead-in wire on the left side.

Next, evaluation method and the bead crack generation in the developed mount according to the embodiment of the present invention will be explained referring to Table 2.

The evaluation was carried out similarly to the conventional one mentioned above. As shown in the data of Table 2, 99 pieces out of 100 P, i.e. 99/100 P did not show the bead crack. The defective 1 piece had a large reduction distance, which does not occur in actual step, and thus it is judged as a good item without problems.

TABLE 1
Confirmation test on bead crack when a pair of lead-in wires
are pressed from left and right sides (conventional sample)

| | A: Initial | | | C: Reduced |
|---|---|---|---|---|
| | distance | B: Lead-in wire | | critical distance |
| | between | distance when | | of crack generation |
| | lead-in wires | bead cracked | | C = (A − B)/2 |
| MIN | 3.65 | Right | 2.54: (3.65 − 1.11) | 0.56 |
| | | side | | |
| | | crack | | |
| | | Left | 1.81: (3.65 − 1.84) | 0.92 |
| | | side | | |
| | | crack | | |
| MAX | 3.72 | Right | 3.23: (3.72 − 0.49) | 0.25 |
| | | side | | |
| | | crack | | |
| | | Left | 3.02: (3.72 − 0.70) | 0.35 |
| | | side | | |
| | | crack | | |
| AVE | 3.671 | Right | 2.939 | 0.366 |
| | | side | | |
| | | crack | | |
| | | Left | 2.431 | 0.620 |
| | | side | | |
| | | crack | | |

(samples N = 100 P, unit: mm)
*Bead crack was generated in all samples until the distance between the lead-in wires becomes “0”.

TABLE 2
Confirmation test on bead crack when a pair of lead-in wires
are pressed from left and right sides (developed sample)

| | | | | C: Reduced |
|---|---|---|---|---|
| | A: Initial | B: Lead-in wire | | critical distance |
| | distance between | distance when | | of crack generation |
| | lead-in wires | bead cracked | | C = (A − B)/2 |
| MIN | 3.49 | Right | No crack at “0” | |
| | | side | | |
| | | crack | | |
| | | Left | No crack at “0” | |
| | | side | | |
| | | crack | | |
| MAX | 3.76 | Right | No crack at “0” | |
| | | side | (99/100 P) | |
| | | crack | | |
| | | Left | No crack at “0” | |
| | | side | | |
| | | crack | | |
| AVE | 3.6465 | Right | Crack occurred | 0.955 |
| | | side | at “1.80” | |
| | | crack | (1/100 P) | |
| | | Left | | |
| | | side | | |
| | | crack | | |
| Cracked | 3.71 | Right | | |
| sample | | side | | |
| | | crack | | |
| | | Left | | |
| | | side | | |
| | | crack | | |

(samples N = 100 P, unit: mm)
*99/100 P did not show bead crack even when lead-in wires space became “0”.
*Though 1/100 P shows bead crack, because the step of reducing 0.5 mm or more of one side does not exist in actual step, the cracked 1 P is judged as a good item without problem.

From the reproduction evaluation test described, it is proved that the generation of the bead chipping or minute cracks in bending step of the lead-in wires is nearly perfectly removed by using the construction and method for manufacturing according to the embodiment of the present invention.///

According to the embodiment, a concave portion is formed at the contact portion of the upper surface of bead and the lead-in wire by mainly heating the lower side surface of the bead, and the generation of the glass bead chipping or minute cracks which are apt to occur in bending step of lead-in wires can almost be avoided. Therefore, production yield can be improved, and a method for manufacturing of electric bulb having excellent reliability can be provided.

According to the embodiment of the method for manufacturing of the present invention, in the heating step of the left and right side surface of mainly lower portion of the bead, the heat power of the central portion of the flame of burner arrayed in horizontal direction is made stronger than those on the both side. Thus, the concave portion which suppresses the rising of the glass of the bead surface along the lead-in wires can be formed more surely. Consequently, generation of glass bead chipping or minute cracks which are apt to occur in bending step of lead-in wires can be nearly avoided. Thus the production yield can be improved and a method for manufacturing of electric bulb having excellent reliability can be provided.

Although the embodiment of the present invention has been explained in detail, the present invention is not limited to the above-mentioned embodiment and various design changes can be made without deviating from the scope of the present invention.

For example, the concave portion formed on the contact portion of outer surface of the bead and the lead-in wire is preferable to be formed on the upper side. That is, the contact portion of the outer surface of the bead and th lead-in wire on the filament side. In other words, it is formed on the root portion of the lead-in wire. However, it may be formed on the lower side of the bead, i.e. on the contact portion of the outer surface of the bead and the lead-in wire on the opposite side of the filament according to the shape or performance.

Further, the concave portion may be formed on the upper and the lower sides of the bead at the contact portions of the lead-in wire and the outer surface of the bead.

The outer surface of the bead need not to be a flat and means a surface of the bead, which is in contact with ambient air, including a bent and bumpy depressed bottom surface when portions of the outer surface of the bead is depressed.

Further, in the explanation of the embodiment above, the description “to suppress the rising of the glass of the surface of the bead along the lead-in wires” means the state at the contact portion of the outer surface of the glass bead and the lead-in wire, where the surface portion of the glass rose up along the lead-in wire. For example, a shape of the cross section at a bead portion rose up is nearly triangle, in which a width at an upper portion is thin and becomes thicker toward lower portion. However, the shape is not limited to the one described but it includes all the states, in which the bead become thin and adhere to the lead-in wire. Further, it does not mean the rising of the bead surface along the lead-in wire does not occur at all, but includes a state where a little bit rising exists and suppression of the rising of the glass is sufficient to the extent to avoid the generation of the glass bead chipping or minute cracks.

Further, in the explanation of the step for mainly heating the lower side surface portion, the side surface means, for example, the side surface in the situation where the ring shaped or cylindrical bead before it is subject to the heating step is arranged horizontally, i.e. it is so arranged that the center hole of the bead stands vertical.

Further, the lower portion of the side surface means the lower portion in the side surface. A strict lower portion is not necessary but a roughly lower portion is meant.

Further, it is preferable to heat the lower portions, which are on diametrically opposite sides of the cylindrical bead. However, heating the lower portion of whole the side surface is permitted.

With respect to the heating method, only the lower portion of the side surface of the bead may be locally heated from diagonally upper direction. It is preferable to heat the lower portion, lower surface portion including the central portion of the side surface and mainly the lower portion of the bead by a relatively narrowed down flame from diagonally upper direction. However, heating lower surface portion including the central portion of side surface is not always a necessary condition. Thus, the size, direction, strength of the flame as well as the heating range can be determined by appropriately selecting as necessary.

Further, it is preferable that preliminary heating step or main baking step is carried out before the step of heating the lower portion of the side surface of the bead, and that the heating step of the lower portion is carried out as a finishing step. However, conducting other heating step before or after the heating step is not a necessary condition and it may be appropriately selected on design basis. Thus, the heating of the lower portion of the side surface of the bead may be carried out in any timing during the process, in which the heating of the bead begins to melt the bead and it is solidified.

1. An electric bulb comprising:
a bead made of glass,
a pair of lead-in wires supported with a space to each other by heating and melting the bead,
a mount composed of a filament suspended between the upper end portions of the pair of lead-in wires, and
an air tight vessel made of translucent material, in which the mount is enclosed and from which a part of the lead-in wires is lead out,
wherein a portion of an outer surface of the bead, which is in contact with the lead-in wires is essentially prevented from rising of the glass along the lead-in wires.

2. An electric bulb comprising:
a bead made of glass,
a pair of lead-in wires supported with a space to each other by heating and melting the bead,
a mount composed of a filament suspended between the top end portions of the pair of lead-in wires, and
an air tight vessel made of translucent material, in which the mount is enclosed and from which a part of the lead-in wires is lead out,
wherein, a concave portion is formed on an outer surface of the bead at a portion, which is in contact portion with the lead-in wires.

3. An electric bulb according to claim 2, wherein the pair of lead-in wires is formed to have a flat cross section at a portion over the outer surface of the bead.

4. An electric bulb according to claim 3, wherein the air tight vessel is a glass bulb, and a part of the lead-in wires is lead out through a sealing portion, which is formed by compressing one end of the glass bulb.

5. A method for manufacturing an electric bulb comprising steps of:
inserting a pair of lead-in wires through a center hole of a bead made of glass so that they are tentatively fixed with a space to each other, and
heating mainly a lower portion of a side surface of the bead in which the pair of lead-in wires is tentatively fixed.

6. A method for manufacturing of an electric bulb according to claim 5, wherein, the glass in the lower portion of the bead melts earlier than the glass in the upper portion, and the lower portion of the center hole is closed first.

7. A method for manufacturing of an electric bulb according to claim 6, wherein the lower portion of the side surface of the bead is heated by a pair of burners having a three tip nozzles arranged nearly in horizontal direction, which are arranged on left and right sides of the bead.

8. A method for manufacturing of an electric bulb according to claim 7, wherein the side surface of the bead is on left or right side of a plain defined by the pair of the lead-in wires.

9. A method for manufacturing of an electric bulb according to claim 8, wherein the center tip nozzle has a diameter larger than those of both sides, and the heat power of the center portion on the side surface of the bead is made stronger than those on both sides.

10. A method for manufacturing of an electric bulb comprising:
a step for inserting a pair of lead-in wires through a center hole of a bead made of glass so that they are tentatively fixed with a space to each other,
a first burner step for mainly heating a whole side surface of the bead through which the pair of lead-in wires is tentatively fixed,
a second burner step for mainly heating a vertically center portion of the side surface of the bead with respect to the direction, and
a third burner step for mainly heating a vertically lower portion of the side surface of the bead.

11. A method for manufacturing an electric bulb according to claim 10, wherein the whole side surface of the bead is heated by a pair of burners having a single tip nozzle, which are arranged on left and right sides of the bead with respect to a plain defined by the pair of the lead-in wires in the first burner step.

12. A method for manufacturing of an electric bulb according to claim 11, wherein the vertically center portion of the side surface of the bead is heated by a pair of burners having two tip nozzles, which are arranged on left and right sides of the bead with respect to a plain defined by the pair of the lead-in wires in the second burner step.

13. A method for manufacturing of an electric bulb according to claim 12, wherein a lower portion of the side surface of the bead is heated by a pair of burners having three tip nozzles, which are arranged on left and right sides of the bead with respect to a plain defined by the pair of the lead-in wires in the third burner step.

14. A method for manufacturing of an electric bulb according to claim 10, wherein the both side surfaces of the bead are heated with respect to a plain defined by the pair of lead-in wires in the third burner step.

15. A method for manufacturing of an electric bulb according to claim 14, wherein a diameter of the tip nozzle of the pair of burners having two tip nozzles is smaller than that of the pair of burners having a single tip nozzle, wherein a diameter the tip nozzle of the pair of burners having three tip nozzles is smaller than those of the pair of burners having two tip nozzles and the center tip nozzle has a larger diameter than those on the both sides, so that a heat power of a central portion is made stronger than those on the both sides at the lower portion of the side surface on the left and right sides of the bead.

16. A method for manufacturing of an electric bulb according to claim 15, wherein the pair of lead-in wires is bent at an upper portion of the bead after the heated and molten bead is solidified, and the space of the top end portions is adjusted.

17. A method for manufacturing of an electric bulb according to claim 16, wherein the mount, on which the pair of lead-in wires is fixed, is enclosed in an air tight vessel composed of a translucent material sealed at one end, with one end of the pair of lead-in wires is lead out of the air tight vessel.
